(19) United States
(12) Patent Application Publication
(10) Pub. No.: US 2026/0112719 A1
(43) Pub. Date: Apr. 23, 2026

(54) APPARATUS AND METHOD FOR INSPECTING BATTERY CELL LEAD TAB

(71) Applicant: SK On Co., Ltd., Seoul (KR)

(72) Inventors: Ung Bae PARK, Daejeon (KR); Yu Ri SONG, Daejeon (KR); Byoung Hak LEE, Daejeon (KR); Jung Taek LIM, Daejeon (KR); Young Jin JANG, Daejeon (KR)

(21) Appl. No.: 19/340,764

(22) Filed: Sep. 25, 2025

(30) Foreign Application Priority Data
Oct. 17, 2024 (KR) 10-2024-0142220

(51) Int. Cl. H01M 10/42; G01B 11/00; G01B 11/30; G01N 21/88

(52) U.S. Cl. CPC H01M 10/4285; G01B 11/002; G01B 11/30; G01N 21/8806

(57) ABSTRACT

Proposed are an apparatus and a method for inspecting battery cell lead tabs to detect a shape defect or surface defect of a lead tab of a battery cell. The apparatus includes a shape measurement device that measures the shape of a lead tab of a battery cell, and a controller that corrects the tilt of the lead tab from the shape data measured by the shape measurement device and detects a defect in the lead tab.

### CROSS REFERENCE TO RELATED APPLICATION

The present application claims priority to Korean Patent Application No. 10-2024-0142220, filed Oct. 17, 2024, the entire contents of which are incorporated herein for all purposes by this reference.

### TECHNICAL FIELD

The present disclosure relates to an apparatus and method for inspecting battery cell lead tabs.

### BACKGROUND

Secondary batteries can be charged and discharged. Secondary batteries are used in electric vehicles, energy storage systems (ESS), portable electronic devices, etc. A battery cell is typically constructed with a negative electrode, a positive electrode, separator, and electrolyte, all housed within a cell case. The lead tabs of the battery cell are connected to either the negative electrode or positive electrode inside the cell case to transmit electrical current to the outside.

Battery cells can be connected in series, parallel, or a combination of both (series-parallel) to form a battery module. Bus bars are used to connect multiple battery cells. The connection between battery cell tabs and busbars is commonly achieved through welding, insertion, and contact.

### SUMMARY

According to an aspect of the present disclosure, provided is an apparatus and method for inspecting battery cell lead tabs seeking to inspect whether a lead tab of a battery cell is defective by detecting the shape of the lead tab and correcting the shape data.

An apparatus and method for inspecting battery cell lead tabs according to an aspect of the present disclosure can be applied to the manufacturing process of batteries widely used in green technology fields such as electric vehicles, battery charging stations, and solar and wind power generation using batteries.

An apparatus and method for inspecting battery cell lead tabs according to an aspect of the present disclosure can be applied to the manufacturing process of batteries used in eco-friendly electric vehicles, hybrid vehicles, etc., which are crucial in combating climate change by reducing air pollution and greenhouse gas emissions.

According to an aspect of the present disclosure, there is provided an apparatus for inspecting battery cell lead tabs, the apparatus including: a shape measurement device configured to measure a shape of a lead tab of a battery cell; and a controller configured to correct a tilt of the lead tab from shape data measured by the shape measurement device and detect a defect in the lead tab.

According to an embodiment, the shape measurement device may be positioned so as to face the lead tab in a direction perpendicular to one surface of the battery cell to measure a three-dimensional shape of a surface of the lead tab.

According to an embodiment, the shape measurement device may include a three-dimensional laser measurement device.

According to an embodiment, the controller may determine a rotation axis for rotating the shape data from the shape data received from the shape measurement device, determine a rotation amount for rotating the shape data, and rotate the shape data by the rotation amount around the rotation axis to correct the tilt of the lead tab.

According to an embodiment, a point that is a boundary between a cell case of the battery cell and the lead tab may be determined as the rotation axis.

According to an embodiment, the rotation amount may be determined by a rotation until an end of the lead tab reaches a line same as the rotation axis in the shape data.

According to an embodiment, the controller may determine an area that deviates from an upper limit or a lower limit among a plurality of measurement points of the shape data as a shape defect, and may determine an area showing a spike shape among the plurality of measurement points of the shape data as a surface defect.

In order to achieve the above objectives, according to an aspect of the present disclosure, there is provided a method for inspecting battery cell lead tabs, the method including: measuring, by a shape measurement device, a shape of a lead tab of a battery cell; correcting, by a controller, a tilt of the lead tab from shape data after receiving the shape data from the shape measurement device; and determining, by the controller, a defect of the lead tab by analyzing the shape data with a tilt correction.

According to an embodiment, in the measuring the shape of the lead tab of the battery cell, the shape measurement device may be positioned so as to face the lead tab in a direction perpendicular to one surface of the battery cell to measure a three-dimensional shape of a surface of the lead tab.

According to an embodiment, the correcting the tilt of the lead tab may include: determining a rotation axis for rotating the shape data in the shape data received from the shape measurement device; determining a rotation amount for rotating the shape data; and rotating the shape data by the rotation amount around the rotation axis.

According to an embodiment, in the determining the rotation axis, a point at a boundary between a cell case of the battery cell and the lead tab may be determined as the rotation axis.

According to an embodiment, in the determining the rotation amount, the rotation amount may be determined by a rotation until an end of the lead tab reaches a line same as the rotation axis in the shape data.

According to an embodiment, the determining the defect of the lead tab may include: determining an area that deviates from an upper limit or a lower limit among a plurality of measurement points of the shape data as a shape defect; and determining an area showing a spike shape among the plurality of measurement points of the shape data as a surface defect.

The features and advantages of the present disclosure will become more apparent from the following detailed description based on the accompanying drawings.

The terms or words used in this specification and claims should not be construed in their usual, dictionary meaning, and should be interpreted with meaning and concept consistent with the technical idea of the present disclosure on the basis of the principle that the inventor can define terminology appropriately to explain his or her invention in the best way possible.

According to an embodiment of the present disclosure, it is possible to detect shape defects such as bending of a lead tab.

According to an embodiment of the present disclosure, it is possible to reduce defects that occur during the process of inserting a lead tab into a groove of a bus bar.

According to an embodiment of the present disclosure, it is possible to detect a surface defect of a lead tab.

### BRIEF DESCRIPTION OF THE DRAWINGS

FIG. 1 is a view showing a battery module including a battery cell.

FIG. 2 is a view showing the connection of a battery cell and a bus bar.

FIG. 3 is a view showing an apparatus for inspecting battery cell lead tabs according to an embodiment.

FIG. 4 is an image showing data measured by a shape measurement device according to an embodiment represented on a heat map.

FIG. 5 is an image generated by rendering data measured by a shape measurement device according to an embodiment.

FIG. 6 is a view showing a controller according to an embodiment.

FIG. 7 is a view showing a type that distinguishes the shape of a lead tab according to an embodiment.

FIG. 8 is a view showing correction of rotating shape data measured by a shape measurement device according to an embodiment.

FIG. 9 is an image showing a heat map before and after shape data correction according to an embodiment.

FIG. 10 is a view showing a surface defect occurred on the coating of a negative electrode lead tab according to an embodiment.

FIG. 11 is a view showing a data profile of a surface defect occurred on a negative electrode coating according to an embodiment, measured using a shape measurement device.

FIG. 12 is a view showing each step of a method for inspecting battery cell lead tabs according to an embodiment.

FIG. 13 is a view showing a step of correcting tilt according to an embodiment.

FIG. 14 is a view showing a step of detecting a defect according to an embodiment.

### DETAILED DESCRIPTION

Hereinafter, the present disclosure will be described in detail (with reference to the attached drawings). However, this is only exemplary and the present disclosure is not limited to the specific embodiments described as exemplary.

Hereinafter, an embodiment of the present disclosure will be described in detail with reference to the attached drawings.

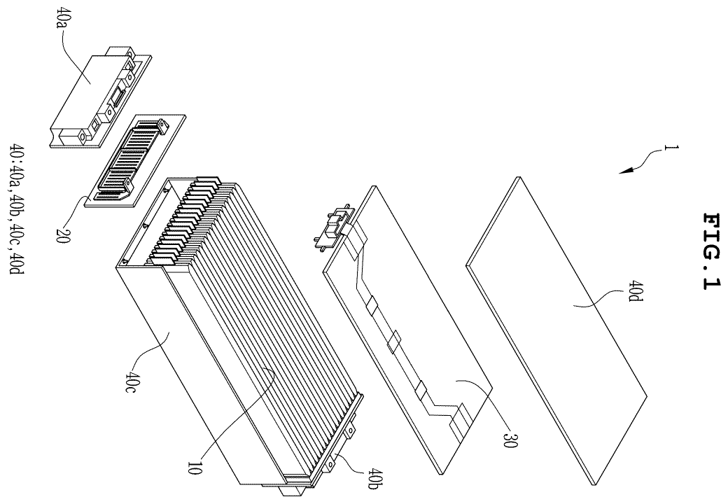

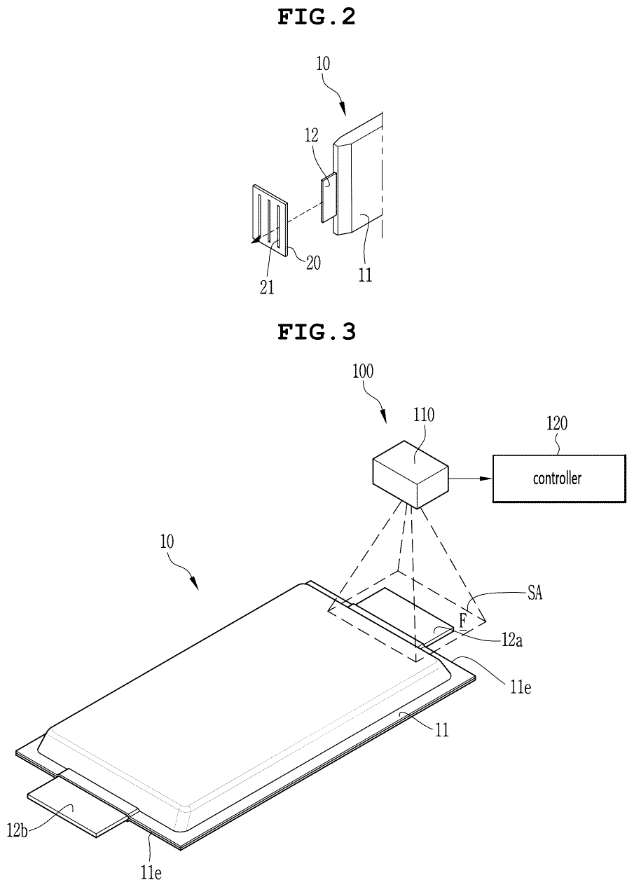

FIG. 1 is a view showing a battery module 1 including a battery cell 10. FIG. 2 is a view showing the connection of the battery cell 10 and a bus bar 20.

The battery module 1 may include a plurality of battery cells 10, a bus bar 20 assembly connected to the battery cells 10, a circuit board 30 that measures the voltage or current of the battery cells 10 and communicates with the outside, and a module case 40 that stores the battery cells 10 inside. The module case 40 of the battery module 1 may be formed by combining a front part 40a, a rear part 40b, a side part 40c, and an upper part 40d with each other. The battery module 1 may further include other configurations in addition to the configuration shown.

The battery cells 10 may be connected to the bus bar 20. The bus bar 20 may connect the battery cells 10 in series, parallel, or series-parallel. The bus bar 20 may be connected to a lead tab 12 of each battery cell 10. The lead tab 12 may include a positive electrode lead tab 12b connected to a positive electrode of the battery cell 10 and a negative electrode lead tab 12a connected to a negative electrode of the battery cell 10. The lead tab 12 may be provided one on each side of the battery cell 10. The lead tab 12 may be provided in parallel on one side of the battery cell 10.

The bus bar 20 may include a thin and long hole 21 into which the lead tab 12 may be inserted. The hole 21 may be formed in a narrow and long shape penetrating the bus bar 20. In case that a portion of the lead tab 12 has a curve or bend, the curved portion may be caught on the hole 21 during the process of inserting the lead tab 12 into the hole 21 of the bus bar 20, resulting in a defect in which the lead tab 12 is folded. The curved portion of the lead tab 12 may come into contact with the hole 21 of the bus bar 20, causing a scratch D2 to occur on a coating 13 of the lead tab 12. The negative electrode lead tab 12a made of copper has a nickel plating layer formed thereon to prevent corrosion. In case that the contact between the curved portion of the negative electrode lead tab 12a and the hole 21 of the bus bar 20 causes the scratch D2 on the nickel plating layer, the copper of the negative electrode lead tab 12a is exposed, causing corrosion of the lead tab 12. In case that the negative electrode lead tab 12a is assembled to the bus bar 20 while the cracks, dents, scratches D2, etc., occur on the nickel coating 13 of the negative electrode lead tab 12a, the copper of the negative electrode lead tab 12a may be exposed and corroded. Since such defects affect the quality of the battery module 1, it is necessary to inspect in advance whether there are any defects in the lead tab 12 of the battery cell 10.

FIG. 3 is a view showing an apparatus 100 for inspecting battery cell lead tabs according to an embodiment.

According to an embodiment, the apparatus 100 for inspecting battery cell lead tabs may include: a shape measurement device 110 that measures the shape of the lead tab 12 of the battery cell 10; and a controller 120 that corrects the tilt of the lead tab 12 from shape data measured by the shape measurement device 110 and detects a defect in the lead tab 12.

The apparatus 100 for inspecting battery cell lead tabs may be used before performing the process of assembling the battery cell 10 and the bus bar 20. After inspecting whether there is a defect in the lead tab 12 of the battery cell 10, the battery cell 10 with the defect may be excluded from the process of assembling the battery cell 10 with the bus bar 20. When there is no defect in the lead tab 12 of the battery cell 10, the process of combining the battery cell 10 and the bus bar 20 may be performed.

The shape measurement device 110 may measure the shape of the lead tab 12 of the battery cell 10 and generate three-dimensional data. The shape measurement device 110 is positioned so as to face the lead tab 12 in a direction perpendicular to one surface of the battery cell 10 to measure the three-dimensional shape of the surface of the lead tab 12. When one surface of the battery cell 10 is referred to as the X-Y plane, the shape measurement device 110 may measure the lead tab 12 of the battery cell 10 in the Z-axis direction perpendicular to the X-Y plane. The shape measurement device 110 may include a three-dimensional laser measurement device. The shape measurement device 110 may measure the shape of the lead tab 12 by measuring the distance from the shape measurement device 110 to the lead tab 12 for each X, Y coordinate of a measurable area.

The shape measurement device 110 may measure a measurement area SA including the lead tab 12 of the battery cell 10. The measurement area SA may be positioned across a cell case 11 of the battery cell 10, the lead tab 12, and a bottom surface F on which the battery cell 10 is placed.

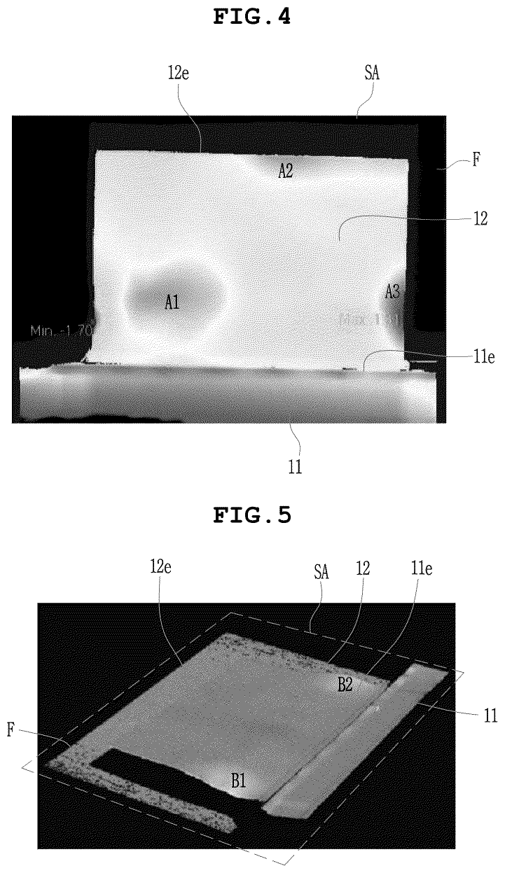

FIG. 4 is an image showing data measured by a shape measurement device according to an embodiment represented on a heat map. FIG. 5 is an image generated by rendering data measured by a shape measurement device according to an embodiment. FIG. 3 is referenced together.

The shape data measured by the shape measurement device 110 may include the distance between the shape measurement device 110 and the lead tab 12. The distance between the shape measurement device 110 and the lead tab 12 may be expressed as a heat map image. The heat map image visually represents the distance value between the shape measurement device 110 and the lead tab 12 using color or brightness variations. The heat map image may include the lead tab 12, an end 12e of the lead tab 12, the cell case 11, an edge 11e of the cell case 11, and the bottom surface F on which the battery cell 10 is placed within the measurement area SA. In FIG. 4, the distance values of an A1 portion, an A2 portion, and an A3 portion of the lead tab 12 are different from those of other portions. When these values are out of a set range, it can be determined that there is a curve, a bend, or a warp in the corresponding portion. If this portion comes into contact with the hole 21 of the bus bar 20, defects such as the lead tab 12 being bent or scratched D2 on the surface thereof may occur during the process of being inserted into the hole 21.

The shape data measured by the shape measurement device 110 may be expressed as a rendered image. The rendered image may be generated from a perspective looking down at one side of the battery cell 10 from an oblique position. In FIG. 5, a B1 portion and a B2 portion of the lead tab 12 have a concave or convex curve shape. The rendered image may include the lead tab 12, the end 12e of the lead tab 12, the cell case 11, the edge 11e of the cell case 11, and the bottom surface F on which the battery cell 10 is placed within the measurement area SA.

The controller 120 may process and display the shape data measured by the shape measurement device 110 as the heat map image of FIG. 4 or the rendered image of FIG. 5. A user can check the heat map image or the rendered image to determine whether a curve, a bend, or a warp exists in the lead tab 12.

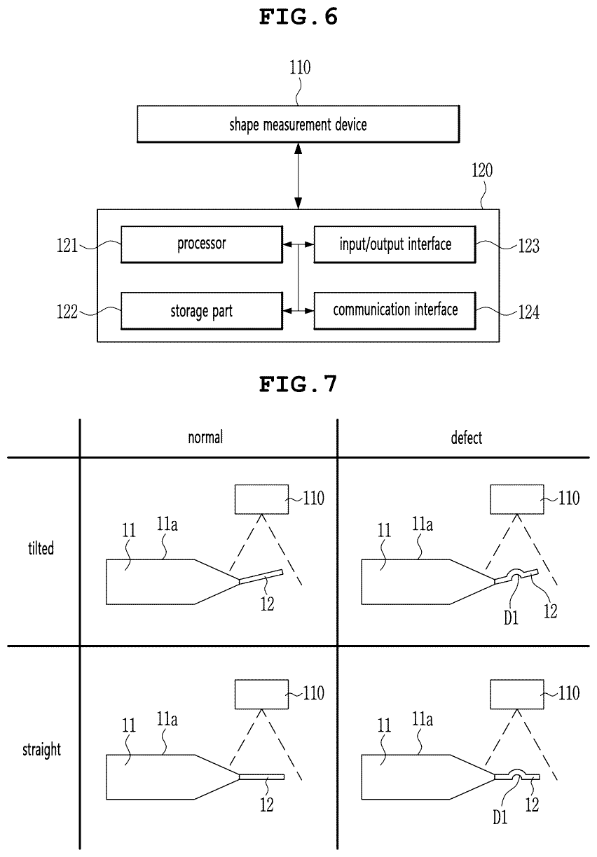

FIG. 6 is a view showing the controller 120 according to an embodiment.

The controller 120 may include a processor 121 and a storage part 122. The processor 121 may read and execute a program code stored in the storage part 122. The storage part 122 and the processor 121 may be connected to enable data transmission and reception. The storage part 122 may store a program code written to perform a method for inspecting the lead tab 12 of the battery cell 10. The storage part 122 may store shape data measured by the shape measurement device 110. The processor 121 may correct the shape data according to the program code stored in the storage part 122 and determine whether a defect exists according to a set standard.

The controller 120 may further include an input/output interface 123 or a communication interface 124. The input/output interface 123 may include a display for providing a user with information that visually represents shape data, such as a heat map image or a rendered image, and a display device, such as a notification light or speaker capable of notifying a user of a defect in the lead tab 12. The input/output interface 123 may include a touchpad, a keyboard, a mouse, or other input devices for a user to input commands or data.

The communication interface 124 may transmit and receive data or commands with the equipment of the battery manufacturing process. The communication interface 124 may transmit and receive data with a device that controls the process equipment. The communication interface 124 may be used to notify the equipment of other processes of which lead tab 12 has a defect. The communication interface 124 may use LAN, WAN, ethernet, IPv4, IPv6, other wired communication methods, 5G, 6G, LTE, other mobile communication methods, short-range communication methods such as wi-fi, Bluetooth, and Zigbee.

FIG. 7 is a view showing a type that distinguishes the shape of the lead tab 12 according to an embodiment. FIG. 3 is referenced together.

The controller 120 may receive shape data measured by the shape measurement device 110. The controller 120 may determine whether there is a defect in the lead tab 12 using the shape data. The controller 120 may correct the tilt of the lead tab 12 from the shape data and then determine whether there is a defect in the lead tab 12. In this case, a defect in the lead tab 12 may include a curve D1, a bend, or a warp of the lead tab 12 in addition to the tilt of the lead tab 12.

The controller 120 may not determine that the presence of a tilt in the lead tab 12 of the battery cell 10 is a defect. This is because the tilted lead tab 12 may be corrected during the process of aligning the lead tab 12 when inserting the lead tab 12 into the hole 21 of the bus bar 20. On the other hand, the presence of the partial curve D1, bend, or warp in the lead tab 12 may be determined as a defect. This is because the presence of the partial curve D1, bend, or warp in the lead tab 12 cannot be corrected during the process of aligning the lead tab 12, and the partial curve D1, bend, or warp in the lead tab 12 causes the lead tab 12 to get caught in the hole 21 of the bus bar 20.

The controller 120 may classify as “normal” a case in which the lead tab 12 is formed straight without being tilted with respect to one side of the battery cell 10 and there is no curve D1. The controller 120 may classify as “normal” a case in which the lead tab 12 is tilted with respect to one side of the battery cell 10 but there is no curve D1. The controller 120 may classify as “defect” a case in which the lead tab 12 is tilted with respect to one side of the battery cell 10 and there is the curve D1. The controller 120 may classify as “defect” a case in which the lead tab 12 is formed straight without being tilted with respect to one side of the battery cell 10 but there is the curve D1.

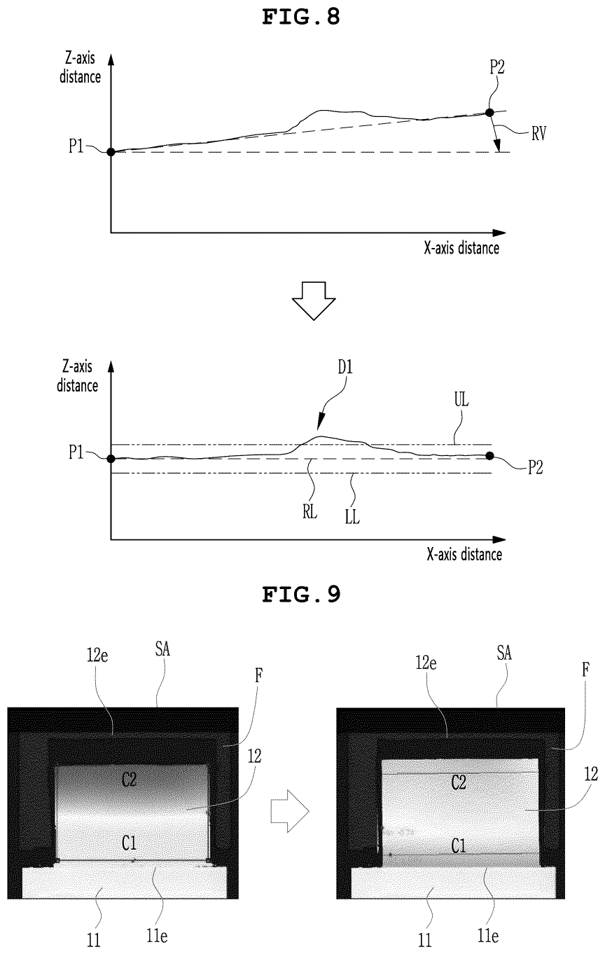

FIG. 8 is a view showing correction of rotating shape data measured by the shape measurement device 110 according to an embodiment.

The upper graph of FIG. 8 shows data measured when the lead tab 12 is tilted toward the shape measurement device 110 with respect to one side of the battery cell 10. In case that the controller 120 determines that a portion that deviates from an upper limit UL and a lower limit LL set is defective by using the shape data received from the shape measurement device 110 as it is, the controller 120 might classify as a defect a case in which the lead tab 12 is formed with tilted with respect to one side of the battery cell 10 and there is no curve. In order to determine that the lead tab 12 with a tilt and no curve as normal, the controller 120 may correct the tilt by rotating the shape data.

From the shape data received from the shape measurement device 110, the controller 120 may determine a rotation axis P1 for rotating the shape data, determine a rotation amount RV for rotating the shape data, and correct the tilt of the lead tab 12 by rotating the shape data around the rotation axis P1 by the rotation amount RV. When the controller 120 corrects the shape data, the data may be corrected as shown in the lower graph of FIG. 8.

The controller 120 may first determine the rotation axis P1 for rotating the shape data. The rotation axis P1 may be determined by a point that is the boundary between the cell case 11 of the battery cell 10 and the lead tab 12. For a portion where the lead tab 12 is inserted inside the cell case 11, since the cell case 11 can support the lead tab 12, the tilt may start at the boundary between the lead tab 12 and the cell case 11. Thus, the rotation axis P1, which is a reference point for rotating the shape data, may be determined by the boundary between the lead tab 12 and the cell case 11. As shown in FIGS. 3 and 4, the boundary between the lead tab 12 and the cell case 11 may be determined based on the fact that the Z-axis data changes abruptly at the edge 11e of the cell case 11.

The controller 120 may determine the rotation amount RV corresponding to the amount by which the shape data is rotated around the rotation axis P1. The rotation amount RV may be determined based on the end of the lead tab 12 (12e in FIG. 4, P2 in FIG. 8) reaching a line RL same as the rotation axis P1 in the shape data. The fact that the end 12e of the lead tab 12 reaches the same line RL as the rotation axis P1 means that the Z-axis data of the end 12e of the lead tab 12 has the same value as the Z-axis data of the rotation axis P1. The angle at which the end 12e of the lead tab 12 is rotated until the end 12e of the lead tab 12 reaches the line RL same as the rotation axis P1 may be referred to as the rotation amount RV.

The controller 120 may rotate each measurement point of the shape data by the rotation amount RV around the rotation axis P1. The shape data includes measurement points specified by X, Y, and Z coordinate values. The controller 120 may rotate the coordinate values of the measurement points corresponding to the lead tab 12 by the rotation amount RV around the rotation axis P1. When the controller 120 rotates the shape data, data like the graph below in FIG. 8 may be obtained. That is, the controller 120 may obtain shape data in which the tilt of the lead tab 12 is corrected. When the shape data measured with the lead tab 12 tilted overall toward the shape measurement device 110 is corrected, the lead tab 12 may be corrected to an overall straight shape parallel to one side of the battery cell 10.

FIG. 9 is an image showing a heat map before and after shape data correction according to an embodiment. FIG. 8 is referenced together.

The left image of FIG. 9 is an image showing shape data before correction represented on a heat map. In the left image of FIG. 9, it can be confirmed that a portion C2 of the end 12e of the lead tab 12 is tilted in the Z-axis direction more than a portion C1 near the boundary 11e between the lead tab 12 and the cell case 11.

When the controller 120 corrects the shape data, a heat map image may be generated as in the right image of FIG. 9. In the heat map image, it can be confirmed that the portion C2 of the end 12e of the lead tab 12 and the portion C2 close to the boundary 11e between the lead tab 12 and the cell case 11 have Z-axis data of similar size overall.

Since the controller 120 corrects the tilt of the lead tab 12 that appears in the shape data and then determines whether there is a shape defect in the lead tab 12, the controller 120 may not determine the tilt of the lead tab 12 as a defect.

The controller 120 may determine an area that deviates from the upper limit UL or the lower limit LL among a plurality of measurement points of shape data as a shape defect, and may determine an area exhibiting a spike shape among the plurality of measurement points of shape data as a surface defect.

The controller 120 may determine whether a shape defect exists by correcting the tilt in the shape data and then determining whether there is a deviation from the upper limit UL or the lower limit LL in the shape data. In this case, a shape defect means that a portion of the lead tab 12 has a curve, a bend, or a warp. When there is a deviation from the upper limit UL or the lower limit LL in the shape data, the controller 120 may determine that the portion of the corresponding lead tab 12 where the deviation occurs has a curve, a bend, or a warp.

The upper limit UL and the lower limit LL, which serve as criteria for the controller 120 to determine shape defects, may refer to the range of curves allowed for a portion of the lead tab 12. This is because when the lead tab 12 has an acceptable degree of curve, bend, or warp, no defect occurs during the process of inserting the lead tab 12 into the hole 21 of the bus bar 20. The upper limit UL and the lower limit LL, which serve as criteria for the controller 120 to determine shape defects, may be determined by considering the width, length, thickness, material of the lead tab 12, the size of the hole 21 of the bus bar 20, etc.

In case that the controller 120 determines that there is a shape defect in the lead tab 12, the controller 120 may output a command to exclude the corresponding battery cell 10 from the next process. The battery cell 10 determined to have a shape defect may not be supplied to the next process, which is the assembly process of the battery cell 10 and the bus bar 20.

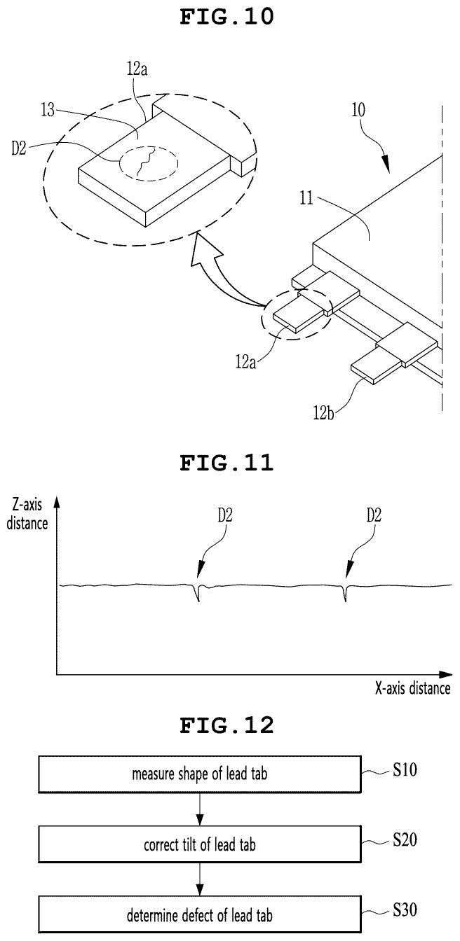

FIG. 10 is a view showing a surface defect occurred on the coating 13 of the negative electrode lead tab 12a according to an embodiment. FIG. 11 is a view showing a data profile of a surface defect occurred on the negative electrode coating 13 according to an embodiment, measured using the shape measurement device 110.

The negative electrode lead tab 12a may have a structure in which nickel is plated on the lead tab 12 made of copper. If a scratch D2, a dent, etc., exists in the nickel plating layer and the nickel plating layer is peeled off and copper is exposed, corrosion, etc., may occur on the negative electrode lead tab 12a. Thus, it is necessary to determine whether a surface defect, such as the scratch D2 or dent, exists on the surface of the negative electrode lead tab 12a. As a method for determining whether a surface defect exists, observing the surface of the lead tab 12 with the naked eye or observing a color change due to corrosion of copper following destruction of the nickel plating layer may be applied, but these methods make it difficult to detect minute defects and it is difficult to detect defects immediately.

The controller 120 may determine whether there is an area showing a spike shape in the shape data. As the shape measurement device 110, a 3D scanner with high X, Y, and Z-axis measurement resolution may be used. The high-resolution 3D scanner used as the shape measurement device 110 may be capable of measuring down to 0.4 μm in the Z-axis. Thus, even a 10 μm defect occurring in the nickel coating 13 can be detected. The resolution of the shape measurement device 110 may vary depending on the device, and the higher the resolution of the device, the more accurately surface defects can be detected. In case that the controller 120 detects that there is a spike-shaped change in Z-axis data in the shape data, the controller 120 may determine that a surface defect exists in the corresponding lead tab 12.

When the shape data measured by the shape measurement device 110 is displayed as a graph, it can be depicted as in FIG. 11. The Z-axis data may be measured along the surface of the lead tab 12, and if there is a surface defect such as the scratch D2 or dent, a spike-shaped portion as shown in FIG. 11 may be identified. The controller 120 may detect the spike-shaped portion and detect whether a surface defect exists in that portion.

In case that the controller 120 determines that there is a surface defect in the lead tab 12, the controller 120 may output a command to exclude the corresponding battery cell 10 from the next process. The battery cell 10 determined to have a surface defect may not be supplied to the next process, which is the assembly process of the battery cell 10 and the bus bar 20.

Battery cells 10 that are determined to have shape defects or surface defects may be subject to an additional process to remove the defects.

FIG. 12 is a view showing each step of a method for inspecting battery cell 10 lead tabs 12 according to an embodiment. FIG. 3 is referenced together.

According to an embodiment, the method for inspecting battery cell 10 lead tabs 12 may include: measuring S10, by a shape measurement device 110, the shape of a lead tab 12 of a battery cell 10; correcting S20, by a controller 120, the tilt of the lead tab 12 from shape data after receiving the shape data from the shape measurement device 110; and determining S30, by the controller 120, a defect of the lead tab 12 by analyzing the shape data with the tilt correction.

The step of measuring S10 the shape of the lead tab 12 may be performed by the shape measurement device 110. The step of measuring S10 the shape of the lead tab 12 may be performed by positioning the shape measurement device 110 so as to face the lead tab 12 in a direction perpendicular to one surface of the battery cell 10 to measure the three-dimensional shape of the surface of the lead tab 12. In the step of measuring S10 the shape of the lead tab 12, the shape measurement device 110 such as a 3D scanner may measure the distance between the lead tab 12 and the shape measurement device 110 using X and Y coordinates thereof to generate shape data.

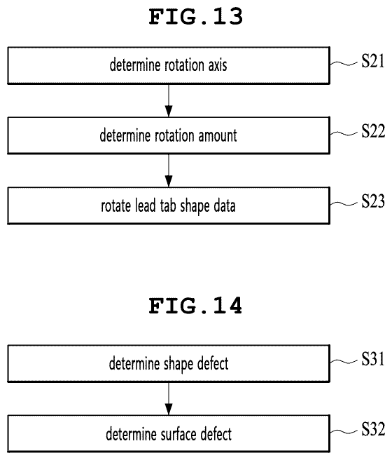

FIG. 13 is a view showing a step of correcting tilt according to an embodiment. FIGS. 8 and 9 are referenced together.

The step of correcting S20 the tilt of the lead tab 12 may be performed by the controller 120. The step of correcting S20 the tilt of the lead tab 12 may include: determining S21 a rotation axis P1 for rotating the shape data in the shape data received from the shape measurement device 110; determining S22 a rotation amount RV for rotating the shape data; and rotating S23 the shape data by the rotation amount RV around the rotation axis P1.

The step of determining S21 the rotation axis P1 is to determine the rotation axis P1 that serves as a reference point for the controller 120 to rotate the shape data. In the step of determining S21 the rotation axis P1, the point that is the boundary between a cell case 11 of the battery cell 10 and the lead tab 12 may be determined as the rotation axis P1. The controller 120 may detect an edge 11e of the cell case 11 of the battery cell 10 from the shape data and determine the edge 11e point of the cell case 11 as the boundary between the cell case 11 and the lead tab 12.

The step of determining S22 the rotation amount RV is to determine the rotation amount RV for the controller 120 to rotate the shape data. In the step of determining S22 the rotation amount RV, the rotation until an end 12e of the lead tab 12 in the shape data reaches the line same as the rotation axis P1 may be determined as the rotation amount RV. The controller 120 may detect the end 12e of the lead tab 12 from the shape data. A point where the Z-axis data of the lead tab 12 changes abruptly may be determined as the end 12e of the lead tab 12. The controller 120 may determine an angle of rotation around the rotation axis P1 so that the measurement point corresponding to the end 12e of the lead tab 12 is located on the same line as the rotation axis P1. The angle may be the rotation amount RV.

The step of rotating S23 the shape data by the rotation amount RV around the rotation axis P1 is to have the controller 120 rotate a plurality of measurement points included in the shape data by the rotation amount RV around the rotation axis P1. The shape data includes measurement points measured along the X-axis, Y-axis, and Z-axis, and the controller 120 may rotate the coordinates of the plurality of measurement points around the rotation axis P1. The controller 120 may correct the tilt of the lead tab 12 in the shape data by rotating all the measurement points by the angle determined as the rotation amount RV1. The shape data before correction indicates that the lead tab 12 is tilted, but the shape data after correction indicates that the lead tab 12 is straight.

FIG. 14 is a view showing a step of detecting a defect according to an embodiment. FIGS. 7 and 11 are referenced together.

The step of determining S30 a defect of the lead tab 12 may be performed by the controller 120. The step of determining S30 a defect of the lead tab 12 may include: determining S31 an area that deviates from an upper limit UL or a lower limit LL among the plurality of measurement points of the shape data as a shape defect; and determining S32 an area showing a spike shape among the plurality of measurement points of the shape data as a surface defect.

The steps of determining S31 a shape defect and determining S32 a surface defect may be performed in parallel and independently. The controller 120 may perform either the step of determining S31 a shape defect or the step of determining S32 a surface defect, or both. The controller 120 may perform the step of determining S31 a shape defect and the step of determining S32 a surface defect simultaneously, or sequentially.

The controller 120 may compare the measurement points of the shape data with the upper limit UL or the lower limit LL, and determine measurement points that deviate from the upper limit UL or the lower limit LL as shape defects. In case that the controller 120 determines that there is a measurement point that deviates from the upper limit UL or the lower limit LL in the corrected shape data, the controller 120 may determine that the corresponding portion has a shape defect. The controller 120 may determine that the battery cell 10 with the lead tab 12 determined to have a shape defect is defective.

The controller 120 may determine that an area exhibiting a spike shape among the measurement points of the shape data is a surface defect. The controller 120 may determine that a spike shape exists when there is a Z-axis data difference greater than a predetermined level at a specific point. The controller 120 may determine that a spike-shaped hole 21 exists on the surface of the lead tab 12 as a surface defect. The controller 120 may determine that the battery cell 10 with the lead tab 12 determined to have a surface defect is defective.

According to the described embodiment, a shape defect such as bending of the lead tab 12 or a surface defect of the lead tab 12 may be detected. Since a battery cell 10 with a shape defect or surface defect may be excluded from the process of assembling a bus bar 20 and a battery cell 10, defects occurring during the process of inserting the lead tab 12 into the hole 21 of the bus bar 20 or defects in which the lead tab 12 is corroded due to a surface defect may be reduced.

Above, the present disclosure has been described in detail through specific embodiments. The above description is merely an example of applying the principles of the present disclosure, and other configurations may be further included without departing from the scope of the present disclosure.

What is claimed is:

1. An apparatus for inspecting battery cell lead tabs, the apparatus comprising:
a shape measurement device configured to measure a shape of a lead tab of a battery cell; and
a controller configured to correct a tilt of the lead tab from shape data measured by the shape measurement device and detect a defect in the lead tab.

2. The apparatus of claim 1, wherein the shape measurement device is positioned so as to face the lead tab in a direction perpendicular to one surface of the battery cell to measure a three-dimensional shape of a surface of the lead tab.

3. The apparatus of claim 1, wherein the shape measurement device includes a three-dimensional laser measurement device.

4. The apparatus of claim 1, wherein the controller determines a rotation axis for rotating the shape data from the shape data received from the shape measurement device, determines a rotation amount for rotating the shape data, and rotates the shape data by the rotation amount around the rotation axis to correct the tilt of the lead tab.

5. The apparatus of claim 4, wherein a point that is a boundary between a cell case of the battery cell and the lead tab is determined as the rotation axis.

6. The apparatus of claim 4, wherein the rotation amount is determined by a rotation until an end of the lead tab reaches a line same as the rotation axis in the shape data.

7. The apparatus of claim 1, wherein the controller determines an area that deviates from an upper limit or a lower limit among a plurality of measurement points of the shape data as a shape defect, and determines an area showing a spike shape among the plurality of measurement points of the shape data as a surface defect.

8. A method for inspecting battery cell lead tabs, the method comprising:
measuring, by a shape measurement device, a shape of a lead tab of a battery cell;
correcting, by a controller, a tilt of the lead tab from shape data after receiving the shape data from the shape measurement device; and
determining, by the controller, a defect of the lead tab by analyzing the shape data with a tilt correction.

9. The method of claim 8, wherein in the measuring the shape of the lead tab of the battery cell, the shape measurement device is positioned so as to face the lead tab in a direction perpendicular to one surface of the battery cell to measure a three-dimensional shape of a surface of the lead tab.

10. The method of claim 8, wherein the correcting the tilt of the lead tab comprises:
determining a rotation axis for rotating the shape data in the shape data received from the shape measurement device;
determining a rotation amount for rotating the shape data; and
rotating the shape data by the rotation amount around the rotation axis.

11. The method of claim 10, wherein in the determining the rotation axis, a point at a boundary between a cell case of the battery cell and the lead tab is determined as the rotation axis.

12. The method of claim 10, wherein in the determining the rotation amount, the rotation amount is determined by a rotation until an end of the lead tab reaches a line same as the rotation axis in the shape data.

13. The method of claim 8, wherein the determining the defect of the lead tab comprises:
determining an area that deviates from an upper limit or a lower limit among a plurality of measurement points of the shape data as a shape defect; and
determining an area showing a spike shape among the plurality of measurement points of the shape data as a surface defect.
